(19) United States
(12) Patent Application Publication
(10) Pub. No.: US 2004/0070299 A1
(43) Pub. Date: Apr. 15, 2004

(54) Anti-gravity machine

(76) Inventor: Christian Michael Cyr, Augusta, ME (US)

Correspondence Address: CHRISTIAN CYR, P.O. BOX 4636, AUGUSTA, ME, 04330, US

(21) Appl. No.: 10/193,563

(22) Filed: Oct. 12, 2002

(51) Int. Cl. H02K 7/09

(52) U.S. Cl. 310/90.5

(57) ABSTRACT

The type of magnetic field this machine produces negates the effects of gravity on objects subjected to it. Since this machine is not included in the U.S. Patent Classifications, it would be considered a new field.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO A SEQUENCE LISTING, A TABLE, OR A COMPUTER PROGRAM LISTING COMPACT DISC APPENDIX

“Not Applicable”

### BACKGROUND OF THE INVENTION

According to the U.S. Patent Classifications this is a new field. I have experimented and studied the effects of magnets on objects.

### BRIEF SUMMARY OF THE INVENTION

Since magnets work in two different ways, by attracting and repelling each other, I propose to harness the repelling effects of magnets through the use of a magnetic field. The advantage of the invention would be to negate the effects of gravity on objects subjected to the repelling magnetic field.

### BRIEF DESCRIPTION OF THE SEVERAL VIEWS OF THE DRAWING

FIG. 1 is three inch copper coil.

FIG. 2 is housing magnet (south pole facing toward FIG. 5 fly wheel).

FIG. 3 is flywheel magnet (south pole facing housing magnet).

FIG. 4 is housing.

FIG. 5 is flywheel.

FIG. 6 is a one half horsepower electric motor.

FIG. 7 is copper coil.

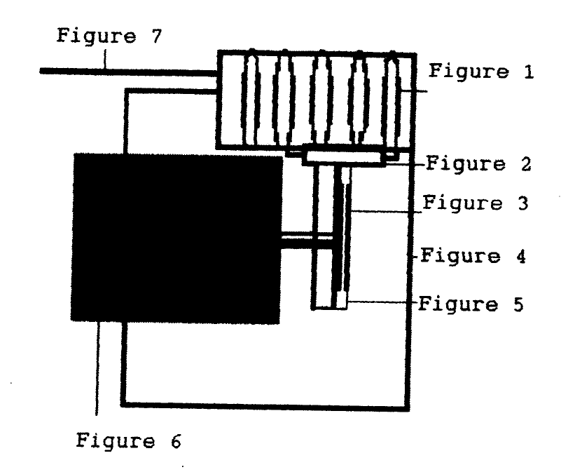

### DETAILED DESCRIPTION OF THE INVENTION

This machine negates the effects of gravity on objects. The machine is comprised of a one half horsepower reciprocating electric motor turning a five-inch aluminum fly wheel. Embedded in the flywheel is a one-inch magnet, south pole facing outwards. In the aluminum housing surrounding the flywheel and motor is another one inch magnet, south pole facing the flywheel within one sixteenth of an inch. A one inch wide by three inch long copper coil surrounds the housing magnet and picks up the magnetic field created by the spinning magnet and sends the current down a ten foot long insulated copper wire. The last three feet of the insulated copper wire is stripped of the insulation and wrapped one time around the base of an object. When the motor is started the object should rise and glide, thus negating the effects of gravity upon that object.

1. What I claim as my invention is a machine that negates the effects of gravity on objects. Different size objects would require different magnetic fields. I claim the type of magnetic field this machine produces.
